(19) United States
(12) Patent Application Publication
(10) Pub. No.: US 2009/0174675 A1
(43) Pub. Date: Jul. 9, 2009

(54) LOCATING MULTIPLE OBJECTS ON A CAPACITIVE TOUCH PAD

(76) Inventors: Dave Gillespie, Los Gatos, CA (US); Tracy Scott Dattalo, Santa Clara, CA (US)

Correspondence Address: SYNAPTICS C/O WAGNER BLECHER LLP, 123 WESTRIDGE DRIVE, WATSONVILLE, CA, 95076, US

(21) Appl. No.: 12/130,904

(22) Filed: May 30, 2008

Related U.S. Application Data
(60) Provisional application No. 61/010,644, filed on Jan. 9, 2008.

(51) Int. Cl. G06F 3/041

(52) U.S. Cl. 345/173

(57) ABSTRACT

A system and method for locating multiple objects on a capacitive touch pad is described. The method for determining locations of a plurality of objects contemporaneously interacting with a capacitive touch pad having a sensing region includes generating a first capacitive profile associated with a first object and a second object contemporaneously in the sensing region and determining locations of the first and second objects with respect to the sensing region utilizing the first capacitive profile.

### RELATED U.S. APPLICATION

This application claims priority to the copending provisional patent application, Ser. No. 61/010,644, Attorney Docket Number SYNA-20080104-A2.PRO, entitled “LOCATING MULTIPLE OBJECTS ON A CAPACITIVE TOUCH PAD,” with filing date Jan. 9, 2008, assigned to the assignee of the present application, and hereby incorporated by reference in its entirety.

### TECHNICAL FIELD

Embodiments of the present invention are related to capacitive touch pads. More particularly, embodiments of the present invention are directed to a capacitive touch pad design and method for improving capacitive touch pad operation.

### BACKGROUND ART

There exist problems with locating multiple fingers (or other input objects) using capacitive touch pads. There also exists a need to locate these input objects accurately enough to allow emulation of keypads or keyboards, such as those with small keys, using touch pad systems.

### SUMMARY

Capacitive touch pads can accept input from a variety of different objects, including fingers, pens, styli, and the like. For most capacitive touch pads, the input objects are conductive. However, capacitive touch pads can be made to accept non-conductive objects. For simplicity and clarity of explanation, the discussion below uses fingers as the example input objects. However, it is understood that any combination of different acceptable objects can produce the profiles used to ascertain the positions of these objects.

When two or more fingers touch or come into sufficient proximity to a capacitive touch pad utilizing a profile sensing scheme, the resulting capacitance profiles are approximately equal to the sums of the profiles that would be due to the fingers separately (i.e. the resulting profiles roughly superimpose the profiles that would result from each of the fingers if it was applied separately in time from any other fingers). In one implementation, a peak interpolation method is used to calculate the location of each finger. For improved interpolation accuracy, a representation of the capacitance profile of the first finger to arrive is saved. This saved profile representation is subtracted from later profiles obtained while a second finger is also interacting with the touch pad to yield modified profiles that isolate the portions of profiles due to the second finger. Even if the captured profile representation of the first finger is not perfectly accurate, subtracting it from a profile obtained with two fingers yields an adjusted profile that is better than the unadjusted profile for measuring the position of the second finger. Various techniques are used to improve the accuracy of the adjustment made to the multiple-finger profile based on the first-finger profile and other information available.

The major existing alternative for accurately locating multiple fingers on a capacitive sensor is known as a “capacitive imaging” sensor, which measures not just row and column capacitances but the separate capacitance of each point on the surface. Imaging sensors require more expensive electronics, higher data rates, and higher power than profile sensors. The present invention allows cheap and simple capacitance profile sensors to perform functions historically attributed to imaging sensors.

Some multi-finger applications for touch pads require that the two touching fingers be not just counted but located accurately. Great care is required in order to locate the fingers accurately enough to allow emulation of keypads or keyboards with very small keys. This invention provides a method for identifying and accurately locating fingers in the presence of multi-finger touch, with enhancements to improve accuracy by taking advantage of the special usage model of a keypad-like application.

This invention is especially suitable for touch pad applications where the fingers rarely move once placed, such as on-screen keyboards or keypads. Embodiments of the present invention include a method for determining locations of a plurality of objects contemporaneously interacting with a capacitive touch pad having a sensing region. The method includes generating a first capacitive profile associated with a first object and a second object contemporaneously in the sensing region and determining locations of the first and second objects with respect to the sensing region utilizing the first capacitive profile.

Embodiments of the present invention also include a capacitance sensing touch pad for determining locations of a plurality of objects. The capacitance sensing touch pad includes a capacitance profile generator coupled with the touch pad for generating a first capacitance profile associated with a first object proximate the touch pad and a position determiner coupled with the profile generator for determining a position of the first object with respect to the touch pad based on the first capacitance profile. In one embodiment, the capacitance profile generator generates a second capacitance profile associated with the first object and a second object simultaneously proximate the touch pad. In one embodiment, a profile adjuster is coupled with the profile generator for determining an adjusted capacitance profile based on the first and second capacitance profiles wherein the position determiner determines a position of the second conductive object with respect to the touch pad based on the adjusted capacitance profile.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 shows two fingers placed on a two-dimensional touch pad in accordance with embodiments of the present invention.

FIG. 2 shows a QWERTY keyboard emulated on a capacitive touch pad in accordance with embodiments of the present invention.

FIG. 3 shows two fingers touching the pad in sequence in accordance with embodiments of the present invention.

FIG. 4 shows a reconstructed second-finger profile in accordance with embodiments of the present invention.

FIG. 5 shows scaling a captured profile in accordance with embodiments of the present invention.

FIG. 6 is a flow chart illustrating a method for determining location information for a plurality of objects interacting with a capacitive touch pad in accordance with embodiments of the present invention.

FIG. 7 is a block diagram of an exemplary system for determining locations of a plurality of objects interacting with a capacitance sensing region of a touch pad in accordance with embodiments of the present invention.

### BEST MODES FOR CARRYING OUT THE INVENTION

Some profile capacitive touch pads, such as X-Y profile touch pads, measure the capacitance on each column and row electrode in a grid of sensor electrodes. These measurements of row and column electrode capacitances form X- and Y-axis capacitance profiles. Each measured value in the profile represents the total capacitance on one row or one column. A finger or other conductive object touching in the sensing region of the pad will increase the capacitances on the rows and columns that fall under or near the finger, producing a characteristic “bump” in each (X-and Y-axis, or Cartesian) profile. It is appreciated that the touch sensor could also be a “linear” sensor, one that produces a one dimensional profile for a single axis. Other touch pads can be designed to sense only along one dimension and produce such a one dimensional profile.

In this sensing scheme, the capacitance change due to a finger will typically be largest on the electrode nearest the center of the finger. If the electrodes are numbered consecutively in each axis profile, the electrode number of a finger's maximal electrode in the X-axis profile provides a rough estimate of the X coordinate of the location of the finger on the surface of the touch pad. Similarly, the number of the finger's maximal electrode in the Y-axis profile estimates the Y coordinate of the finger location.

Conventional capacitive touch pads use an interpolation method to calculate the location of a finger on the pad to a resolution much finer than the physical spacing of the electrodes. One such method, called “peak interpolation,” applies a mathematical formula to a maximal capacitance value and its neighboring values in a profile to estimate the precise center of the capacitance “bump” due to a finger.

When two objects are interacting contemporaneously with a touch sensing system, such as when two fingers are placed on a touch pad, peak interpolation can be applied separately about the peak of each finger “bump” to determine the independent positions of the respective fingers. This works well if the fingers are spaced relatively far apart so that the profile bumps due to the two fingers do not overlap.

In one embodiment, each “bump” can be defined as the vicinity of a “peak” electrode higher in capacitance than its neighboring electrodes (a local maximum of capacitance) and whose capacitance value exceeds some threshold chosen based on the desired touch sensitivity of the sensor. Fluctuations due to electrical noise and electrode sensitivity variation can cause this simple method to falsely count a single finger as two bumps.

Various alternative embodiments are known that can eliminate such artifacts. One such method looks for groups of adjacent electrodes all of which exceed a threshold; another method processes the profiles to reduce fluctuations before searching for bumps. Any method for identifying finger bumps in a capacitance profile may be used with the present invention. However, the present invention may permit a candidate second bump to be isolated and subjected to additional criteria such as a “Z” calculation before being accepted as a second finger. For this reason, the simple definition of “peaks” and “bumps” will suffice for use with the present invention despite its potential for artifacts.

One embodiment of the invention uses three-value peak interpolation. However, the invention is not limited to three-value peak interpolation; any method that calculates the position of a finger from a set of capacitance values can be used.

For example, a centroid calculation can be used as the interpolation method for the present invention. Peak interpolation can be also used because it is simple yet relatively immune to hover effects. This is useful, for example, in systems designed to ignore other objects hovering from the touch pad at a distance beyond a threshold, or to distinguish between touch and hover or different levels of hover. For example, if a second finger is not yet touching the pad but is held near enough to create a small amount of capacitance, this extra capacitance will tend to perturb a centroid calculation that combines measurements from the entire pad surface. Extra capacitance from a hovering finger will have less effect on peak interpolation, which combines measurements from only the neighborhood of the intended finger. In general, local interpolation methods (those that examine only electrodes in the vicinity of the finger) are preferable when locating multiple fingers on a touch pad.

In some applications, the accuracy achievable by applying peak interpolation independently to each finger bump may suffice. For example, this would be true if the fingers are expected to be held a certain distance apart in both (e.g. X and Y) dimensions of a two-dimensional input system (e.g. X-Y touch pad). It would also be true if the distance between the fingers is needed in only the more-distant dimension. For example, a “two-finger pinch” gesture can be implemented that depends on changes in the distance between two fingers but not on the absolute positions of the fingers.

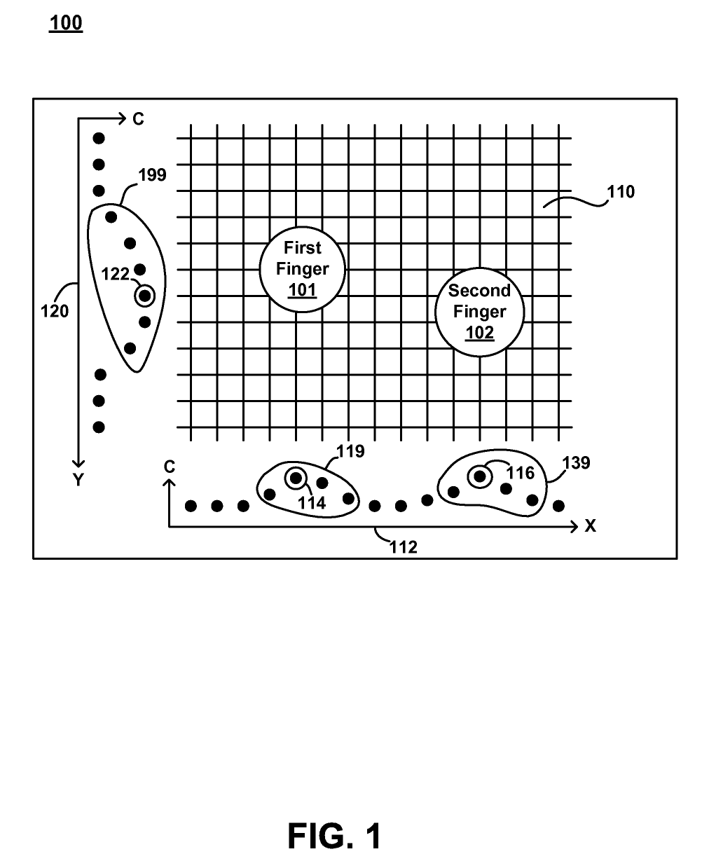

In this “pinch” gesture, the user moves the two fingers closer together or farther apart to perform some action in the user interface such as adjusting the zoom level of a user interface window or adjusting the volume of an audio output. The “pinch” gesture can be implemented on an X-Y capacitance profile sensor device by defining the pinch distance as the greater of the distance between finger bumps in the X-axis profile and the distance between finger bumps in the Y-axis profile. Even if the fingers are held as shown in FIG. 1 such a “pinch” gesture will accurately represent the distance between the fingers because the fingers are far apart in their X coordinates. Analogous methods can be used with one-dimensional capacitance profile touch pads or two-dimensional capacitance profile touch pads laid out in another manner (e.g. in polar coordinates).

However, other applications may require the locations of two fingers to be determined accurately regardless of the placement of the fingers. For such applications, independent peak interpolation may perform poorly because the fingers may be near enough for their bumps to overlap in at least one axis.

When the two fingers are near to each other, the capacitance profile that results is approximately equal to the electrode-wise sum of the profiles due to each finger individually. This is a consequence of fact that the capacitance of two capacitors connected in parallel is equal to the sum of their capacitances. Even if the sensor device measures a mildly non-linear function of capacitance, it often suffices to approximate the combined profile as a simple sum.

FIG. 1 shows two fingers 101 and 102 placed on a two-dimensional touch pad 110 in accordance with embodiments of the present invention. On a two-dimensional touch pad 110, it is possible for the bumps 119 and 139 due to two fingers to overlap in one axis even if the fingers are spaced at a comfortable distance in the two-dimensional plane. For example, when two fingers are placed as shown by the two circles shown in FIG. 1, the X-axis profile 112 shows two distinct peaks 114 and 116 within bumps 119 and 139, respectively, whose positions can easily be calculated by two independent applications of peak interpolation. But the Y-axis profile 120 shows a single peak 122 within bump 199 because the fingers 101 and 102 are very near to each other in their Y coordinates.

Even if the finger 102 on the right in FIG. 1 is far enough downwards from the first finger 101 on the left, so that the Y-axis profile 120 resolves into two peaks, the bumps due to the fingers may still overlap. The values of the neighboring electrodes of each finger are affected by the capacitance of the other finger, causing the calculated coordinate of each finger to be perturbed.

To resolve the positions of two overlapping fingers accurately, the present invention uses the changes over time in the profiles to disambiguate the two fingers. The techniques of this invention work well in applications where each finger can be assumed to hold in a steady position once it has been placed on the touch pad.

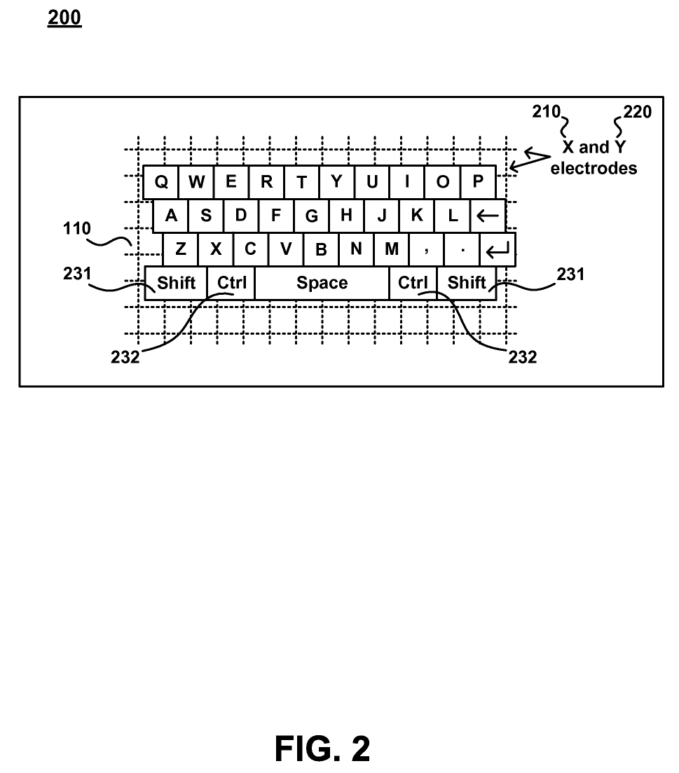

FIG. 2 shows a QWERTY keyboard 200 emulated on a capacitive touch pad 110 in accordance with embodiments of the present invention. Keyboard 200 is an example application in which fingers typically do not move once placed is a two-dimensional capacitive touch pad used to emulate key input, such as a 12-key telephone keypad, a two-dimensional gamepad, or a full QWERTY keyboard as shown. The key input regions of keyboard 200 could be marked in any of various well-known ways, such as by inked lines on the surface of an opaque touch pad, backlit markings in a semi-opaque touch pad, or an image on a touch screen implemented using a transparent touch pad over an LCD display. Interpolation allows a capacitive touch pad to resolve the position of a finger with sufficient accuracy to identify which key of the keypad was “pressed” even if the virtual keys are spaced just a few millimeters apart.

The user of the capacitive keypad 200 might use two fingers to touch two separate keys at the same time. For example, the user may press a modifier key such as Shift 231 or Ctrl 323 together with another key. Multiple key presses can also occur when the user presses a new key before releasing a previously typed key. This situation, known as “two-key rollover,” often arises during rapid typing. In each scenario, it is imperative that the positions of both fingers be interpolated accurately.

The present invention is not limited to keypad applications. Any use for a touch pad in which two or more fingers must be placed accurately will benefit from this invention. For example, the invention could be used for a touch screen that displays large or small icons or other controls.

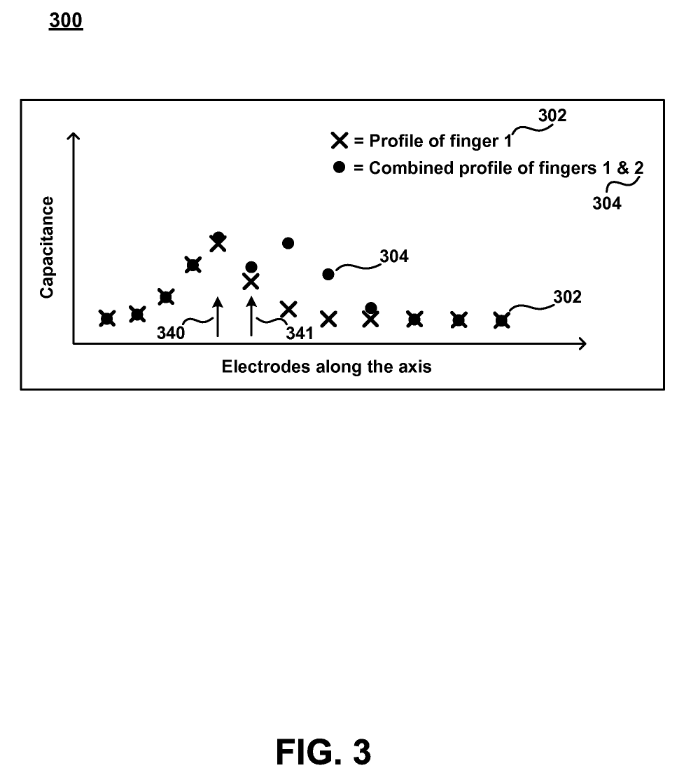

FIG. 3 shows two fingers touching a capacitance sensing pad in sequence in accordance with embodiments of the present invention. FIG. 3 depicts the evolution of a representative axis profile 300 (a Y-axis profile is shown) as one finger first touches the touch pad (producing the profile 302 marked with “x”s), and then the first finger holds steadily on the pad while a second finger touches the pad (producing the profile marked with dots 304).

When the second finger arrives, the interpolated position of the first finger will shift as the measurements of the electrodes marked with arrows 340 and 341 in FIG. 3 increase due to the proximity of the second finger. However, in the kinds of applications noted above, the first finger can be assumed to hold in a steady position once it has been placed on the touch pad. After a second finger arrives, there is no need to recalculate the interpolated position of the first finger, or to report the position if it is recalculated, so it does not matter that its calculated position would be perturbed by the presence of the second finger.

The position calculation for the second finger is also perturbed by the presence of the first finger. The first finger might remain present throughout the period of presence of the second finger. For example, the first finger could hold a Shift key while the second finger types and releases a letter key. For this reason, it may not be possible to capture a clear picture of the second-finger profile directly from the capacitance measurements; every profile measurement that includes the second finger also includes the first finger.

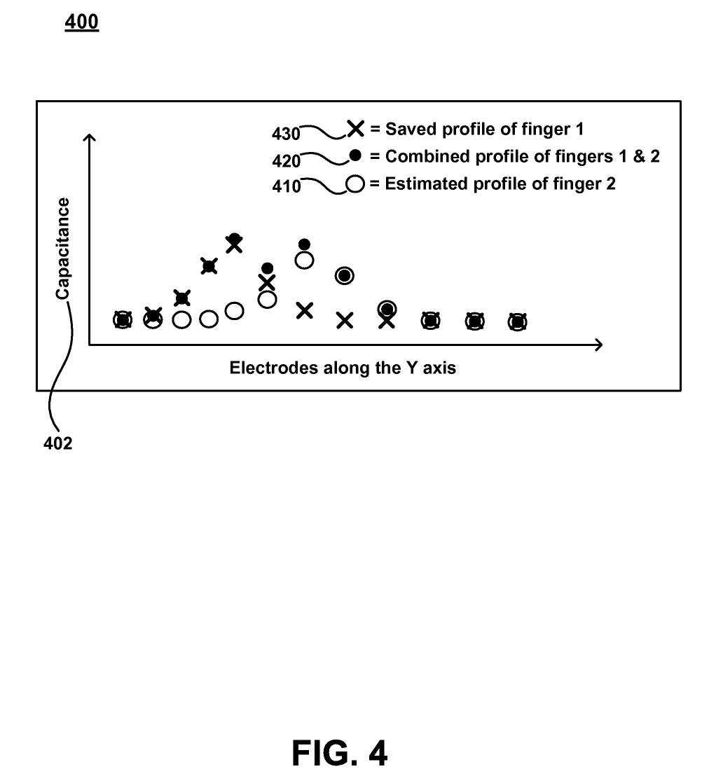

FIG. 4 shows a reconstructed second-finger profile 400 in accordance with embodiments of the present invention. To interpolate the position of the second finger accurately, the present invention subtracts a stored copy of the first-finger profile 430 from the currently measured profile 420 to construct an adjusted profile 410 that estimates the profile due to the second finger alone. As shown in FIG. 4, the capacitance 402 of each electrode due to the second finger is approximated as the measured capacitance of the electrode 420 minus the recorded capacitance of the electrode due to the first finger alone 430.

In conventional touch pads, a baseline profile is stored and then subtracted from the currently measured profile to remove background capacitance. These conventional touch pads take great pains to capture the baseline profile only when no finger is present. The present invention may include the usual calibration and baseline profile processing of a conventional touch pad, however, the present invention also captures an additional profile that deliberately includes the effects of capacitance due to the first finger. This additional captured profile is the one marked with “x”s 430 in FIG. 4 of the present application.

An interpolation method is applied to the adjusted profile to calculate the position of the second finger. Again, any interpolation method may be used, not necessarily the same method that was used to locate the first finger. The adjustment to the profile could also be incorporated into the formula for interpolating the second finger position instead of being done as a distinct step. For simplicity, one embodiment of the invention uses a distinct profile adjustment step (scaling or some other modification of the profile) followed by the same kind of three-value peak interpolation method that is used to locate the first finger.

In actual practice, the first finger rarely remains completely motionless as the second finger touches the pad. For instance, in a standard touch pad implementation, the capacitance due to a finger, and hence the height of the finger bump, rises as the finger lands more and more firmly on the sensor device's surface. Fingers may touch in rapid succession, so the first-finger profile must be captured soon after the first finger touches in order to ensure that it is largely free of second-finger capacitance. But if the first-finger profile or a representation of the first-finger profile is saved very early, when the first finger is initially detected, then the saved image of the first-finger bump is likely to be much smaller than the same bump will be by the time the second-finger interpolation is performed. Subtracting a saved profile with a much smaller bump will only partially erase the first finger, and thus the second-finger position calculation will still be perturbed.

It is possible to record many finger profiles throughout the time between the arrival of the first finger and the arrival of the second finger, and then to choose the best one retrospectively once the second finger is detected. However, it may be that none of the recorded profiles capture a full-sized first-finger bump with no presence of the second finger, especially if the user types rapidly with two hands, or if the user uses two fingers of the same hand and the hand as a whole moves in the action of placing the second finger. Also, it may not be feasible to record many profiles in the memories of the small chips that are typically used to operate touch pad sensor devices. Instead, one embodiment of this invention captures a single, very early first-finger profile and then computes the adjusted profile by subtracting a scaled version of the saved profile.

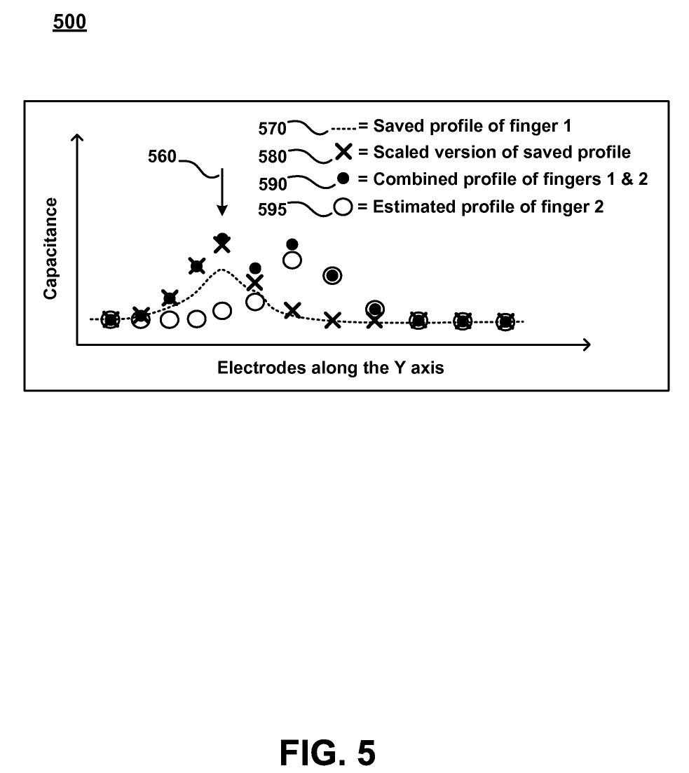

FIG. 5 is an illustration 500 of an early first-finger profile 570 and an adjusted profile 595 generated by subtracting a scaled version of the saved profile 580 in accordance with embodiments of the present invention. The scale factor can be calculated based on the first finger's peak electrode, marked by arrow 560. For each axis (e.g. X and Y), a tentative scale factor is calculated as the ratio of the present capacitance of that electrode divided by the capacitance recorded for that electrode in the first-finger profile. The tentative scale factor may come to less than 1.0, for example, if the first finger has moved slightly away from its original position; in this case, the scale factor is forced to 1.0 in this embodiment on the assumption that the recorded profile may still be a good enough approximation to be useful.

Similarly, it may be beneficial to limit the scale factor to some maximum such as 10.0 in order to avoid numerical overflows in case unusual usage patterns violate the assumptions of the scaling algorithm.

If the fingers overlap in one axis as shown in FIG. 5, the first-finger peak electrode on the overlapping axis may be influenced by capacitance from the second finger, which will inflate the tentative scale factor for that axis by too much to be usable. One X-Y capacitive profile touch pad embodiment of the invention chooses the smaller of the X- and Y-axis tentative scale factors as a shared scale factor for multiplicatively scaling both the X- and Y-axis recorded profiles. It is reasonable to use the same scale factor for both axes because capacitance is a linear phenomenon.

The X-axis electrodes together cover the same surface area as the Y-axis electrodes, so a doubling of finger capacitance sensed by one axis must necessarily correspond with a doubling of capacitance sensed by the other axis. The X- and Y-axis bumps might not change in perfect unison due to inaccuracies or nonlinearity in the capacitance measurements, or because the first finger has shifted its position since it was captured, but the adjustment will generally be close enough to allow acceptably accurate interpolation of the second-finger position.

Although this invention can be used for applications where the finger is not expected to move once placed on the pad, nevertheless it is good for the performance to degrade gracefully if the first finger moves unexpectedly. When subtracting the scaled first-finger capacitance from the present capacitance, the resulting value for any electrode is forced to zero if the difference would have been negative. This ensures that although the adjustment step may undesirably erode the bump of the second finger if the first finger moves, it will not produce a dramatically unrealistic profile such as an “inverted bump” that might cause gross malfunction in subsequent calculations.

Alternatively, the scale factor could be allowed to drop all the way to 0.0 when the first finger seems to have moved from its original location. This alternative embodiment might be preferable for applications in which fingers are more likely to move once placed, and reliably sensing at least the presence and general location of a second finger is more important than locating the second finger with optimal accuracy.

If the touch pad's sensor measurements are susceptible to additive common offsets or noise, it is best to remove these additive offsets before applying the methods of this invention, in order for the multiplicative scaling of the saved profile to work effectively. Techniques for removing common offsets are well-known in the art, such as subtracting the lowest value in the profile from the entire profile, or subtracting the value of a reference electrode that is not exposed to touch.

As a further measure to avoid capturing a hovering second finger as part of the first-finger profile, the preferred embodiment applies the adjustment step only to the electrodes in the vicinity of the first-finger peak. As presently preferred, the first-finger peak electrode and its three nearest neighbors on each side are adjusted for each axis, but more distant electrodes are not adjusted. The number of electrodes adjusted is chosen based on the largest likely size of a finger in the intended application. Adjusting just a subset of the electrodes also allows further memory savings for implementation in small chips. Alternatively, the more-distant electrodes can be adjusted but with a reduced scale factor.

The presently preferred embodiment captures the actual profile capacitances of the electrodes in the vicinity of the first finger, but equivalent alternatives are possible that use a simplified or processed first-finger bump to adjust the profiles. For example, an artificial bump could be calculated based on the known typical shapes of finger bumps and the previously calculated position of the first finger. This alternative is likely to do a poorer job of canceling the first finger than would a scaled version of the actually recorded first-finger profile; however, an artificial bump may be preferable if memory resources are extremely scarce.

The first-finger profile is preferably captured each time a first finger touches the pad, and also each time a second finger is removed from the pad leaving just one finger remaining. For example, if finger A touches the pad, and then finger B touches the pad, and then finger A leaves the pad, finger B is now the sole finger and should play the role of “first finger” for purposes of interpolating any finger C that touches the pad while finger B is still present.

If the first finger might have moved from its original position, and neither axis profile shows evidence of a second finger, it may be desirable to recapture the first-finger profile periodically. For applications that do not expect the first finger to move once placed, it should suffice to capture the profile for a given first finger just once.

The finger position can be calculated just once when a finger is first detected, or, in some applications, it is preferable to recalculate the finger position for as long as it is present in order to track a moving finger. The profile adjustment technique of the present invention assumes the first finger will remain stationary when two fingers are present, but the finger can be detected and tracked by conventional touch pad algorithms when only one finger is present.

For example, many touch pads calculate a “Z” value in addition to any calculation of position coordinates, and they compare this Z value to a threshold with hysteresis in order to detect the finger. In one embodiment, Z is a representation of the height or area of the finger bump. There have been multiple formulas used to derive this Z value. Touch pads using the present invention could continue to apply these Z-based methods for detecting the first finger.

The simplest way to determine when a second finger is present is to check for a bump of sufficient height in each of the adjusted profiles in each axis. However, this simple method is easily fooled; for example, if a single finger touches down in one place and then slides to a significantly different position, the finger bump will reappear in the adjusted profile and could be mistaken as a second finger. To avoid this problem, the present invention checks the adjusted profile for a second finger bump only if the unadjusted profile shows signs of two distinct finger bumps in at least one axis.

Various methods can be used for this determination, such as counting distinct peaks in the profile, or counting distinct regions in the profile that exceed a threshold value. Alternatively, the presence of a second finger may be validated by checking that new bumps appear in the adjusted profile while the original first-finger peak electrodes still show substantial measurements in the unadjusted profile.

Once examination of the unadjusted profiles shows evidence of two fingers, any of the conventional methods for detecting a finger on a touch pad can be applied to the adjusted profiles in order to confirm the presence of a second finger. For example, a second Z value can be calculated based on the adjusted profiles and compared against a suitable threshold with hysteresis.

When two fingers are present it is possible to track motion of the second finger provided that the first finger remains stationary; this is unlikely to be useful in a keypad application, but it could be a realistic usage pattern in a different kind of application that can make use of the present invention. For example, one finger could be held steady on an icon or command button while the other finger is moved to operate an on-screen scroll bar. Or a second finger could be rotated about a fixed first finger to produce a “pivot gesture” for rotating or otherwise adjusting the contents of a window.

If two fingers touch the pad simultaneously, so that one set of measured profiles along all axes of the touch pad show no fingers and the very next set of measurements show signs of two finger bumps in at least one axis, then there is no way to capture a profile of a first finger. In this case, the present embodiment falls back to operating without profile adjustment. For example, an X-Y embodiment interpolates around each bump in the unadjusted profile, using the same X (or Y) coordinate for both fingers if the X-axis (or Y-axis) profile has only one bump. In some applications such as typing on keyboards, where there is a known maximum reasonable typing speed, a suitable alternative would be to measure successive profiles at a high enough rate to resolve all reasonable finger transitions, and to ignore as invalid a second finger that arrives simultaneously with a first finger within the same measurement period.

Some applications might take no special action when a finger leaves the touch pad. For example, a 12-key phone keypad might only need to record the arrivals of fingers on keys. For applications that do need to act upon the removal of a second finger, this event can be marked when the number of finger bumps reduces to 1 on all axes (e.g. both axes of a two-dimensional profile touch pad). To determine which one of the two fingers was removed and which one remains, the coordinates of the remaining finger can be calculated and compared against the last-known positions of the two fingers. Provided that successive profiles are measured rapidly compared to the speed of typical finger motions, the remaining finger can be identified as the nearest of the prior two fingers.

If one finger leaves the pad while another simultaneously touches the pad, the number of finger bumps will remain the same (at “one bump”) from one set of measurements to the next. In the present embodiment, this situation is distinguished from ordinary motion of a single finger by checking for an impossibly large jump in at least one (e.g. X or Y) calculated finger coordinate from one measurement to the next.

Once calculated, the interpolated finger coordinates may be used in whatever way is appropriate to the specific application. For example, in a simple QWERTY keyboard emulation using an X-Y touch pad, each time a first or second finger touches down, its X and Y coordinates could be calculated and compared against the bounding boxes of the various virtual keys to decide which key was pressed. The appropriate letter is typed or the appropriate Shift-like modifier is activated depending on the key. When a finger leaves the pad, no action need be taken except for deactivating any Shift-like modifier that was activated by the finger's arrival.

If the application calls for the simultaneous location of three or more fingers, the methods just disclosed can be extended in a straightforward way. For example, each time the number of finger bumps computed from the unadjusted profile increases or decreases, the saved profile can be updated from the latest profile. When the number of finger bumps increases from two to three, the saved profile will therefore reflect both of the first two fingers, allowing the third finger to be revealed through an adjustment method. However, it will usually suffice to locate just two fingers accurately because it is hard for a user to place more than two fingers on a small touch pad with great accuracy.

The techniques of the present invention may allow more reliable counting of multiple fingers on the touch pad even in applications that do not require the positions of the respective fingers to be calculated accurately.

The techniques just described can be implemented as part of the basic processing of a touch pad device, in which case the calculated finger coordinates will typically be reported to a host in the form of packets or device registers. A variety of alternative implementation methods are possible and also fall within the scope of this invention; for example, profile data could be sent to a host processor and some or all of the processing of profiles into calculated positions could be performed in host software. Or, the calculated coordinates could be converted into keypad key identifiers before transmission to a host. Or, the profile adjustment operation could be implemented as part of the hardware that measures and delivers capacitance profiles to higher-level processing.

Table 1 shows an outline of an example implementation of one embodiment of this invention. This is only an example, and many equivalent implementations are possible.

TABLE 1
Each time a measurement (x_profile and y_profile) is taken:

Perform normal touch pad profile processing such as calibration and baseline subtraction.
Count finger bumps (either 0, 1, or 2) in x_profile and also in y_profile.
Set finger_bump_count = max(x_finger_bump_count, y_finger_bump_count).
Perform normal touch pad finger processing using x_profile and y_profile:

Find the electrode x_Nmax in x_profile corresponding to the finger; also find y_Nmax in y_profile.
Use peak interpolation to calculate X and Y coordinates.
Calculate Z and any other desired properties of the first finger.

If finger_bump_count changed to 1 from either 0 or 2:

Set x_saved = x_profile and y_saved = y_profile.
Set x_Nmax_saved = x_Nmax and y_Nmax_saved = y_Nmax.

If normal finger processing confirms that at least one finger is present:

Report (X,Y,Z) to the host if the first finger has just arrived,

or if the X or Y coordinate has instantaneously changed by a large amount.

If finger_bump_count is 2:

Calculate x_scale = x_profile[x_Nmax_saved] / x_saved[x_Nmax_saved]; same for y_scale.
Set scale = min(x_scale, y_scale), limited to a suitable range such as (1.0 to 10.0),

or set scale = 0.0 if finger_bump_count changed instantaneously from 0 to 2.

Calculate x_adjusted = x_profile-(x_saved * scale) for each electrode near x_Nmax_saved

limited to be 0 or above; also calculate y_adjusted.

Set x_adjusted = x_profile for electrodes far from x_Nmax_saved; same for y_adjusted.
Perform second touch pad finger processing using x_adjusted and y_adjusted profiles:

Find x_Nmax_2 in x_adjusted, choosing a different electrode than x_Nmax if possible;

also find y_Nmax_2.

Calculate X2, Y2, Z2, and any other desired properties of the second finger.

If second finger processing confirms that a second finger is present:

Report (X2,Y2,Z2) to the host if the second finger has just arrived.

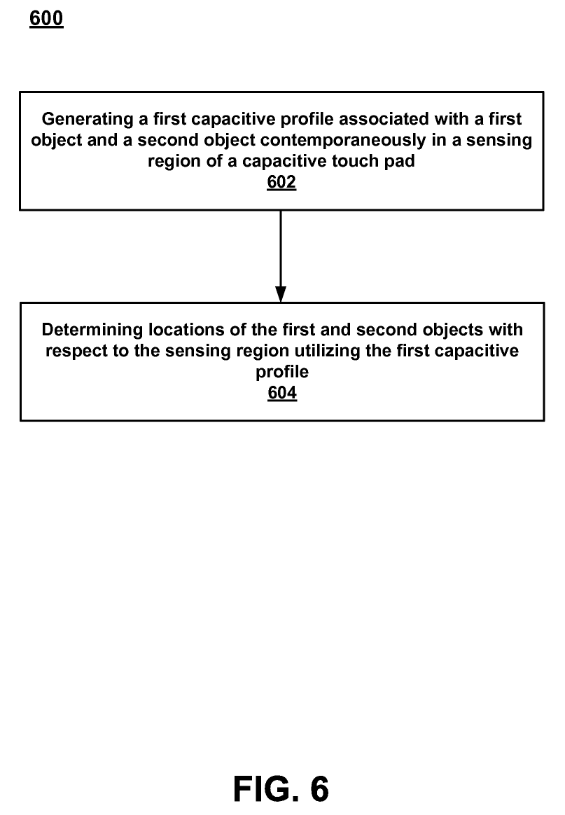

FIG. 6 is a flow chart illustrating a method 600 for determining location information for a plurality of objects interacting with a capacitive touch pad in accordance with embodiments of the present invention. FIG. 6 shows one embodiment, and other embodiments are contemplated. For example, the steps shown in FIG. 6 can take place in a different order other than shown.

At 602, 600 includes generating a first capacitance profile associated with a first object and a second object contemporaneously in a sensing region of a capacitance sensing touch pad. In one embodiment, local interpolation is performed on the capacitance profile.

At 604, 600 includes determining locations of the first and second objects with respect to the sensing region utilizing the first capacitive profile.

In one embodiment, 602 includes determining capacitance values associated with the first and second objects with respect to a first axis of the sensing region and 604 includes determining locations of the first and second objects in the first axis.

In one embodiment, 602 includes determining capacitance values associated with the first and second objects with respect to a second axis of the sensing region and 604 includes determining locations of the first and second objects in the second axis.

In one embodiment, 600 further includes determining a relationship between the locations in the first axis and the second axis and using the relationship to control a user interface.

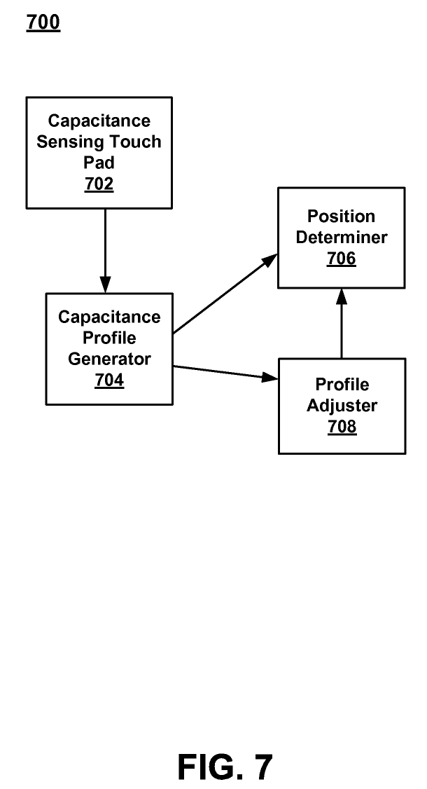

FIG. 7 is a block diagram 700 of an exemplary system for determining locations of a plurality of objects interacting with a capacitance sensing region of a touch pad in accordance with embodiments of the present invention.

In one embodiment, capacitance sensing touch pad 702 is coupled with a capacitance profile generator 704. In one embodiment, the capacitance sensing touch pad includes capacitance sensors in one or more axis. The capacitance profile generator 704 generates a first capacitance profile associated with a first object proximate the touch pad. The capacitance profile generator also generates a second capacitance profile associated with the first object and a second object simultaneously proximate the touch pad 702.

A position determiner 706 is coupled with the capacitance profile generator 704 for determining a position of an object with respect to the sensing region of the touch pad 702 based on the first capacitance profile.

A profile adjuster 708 is coupled with the profile generator for determining an adjusted capacitance profile based on the first and second capacitance profiles. The position determiner 706 determines the positions of the first and second objects based on the adjusted capacitance profile.

Example embodiments of the subject matter are thus described. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is Claimed is:

1. A method for determining locations of a plurality of objects contemporaneously interacting with a capacitive touch pad having a sensing region, the method comprising:
generating a first capacitive profile associated with a first object and a second object contemporaneously in said sensing region; and
determining locations of said first and second objects with respect to said sensing region utilizing said first capacitive profile.

2. The method of claim 1 wherein determining locations of said first and second objects with respect to said sensing region comprises:
determining capacitance values associated with said first and second objects with respect to a first axis of said sensing region; and
determining locations of said first and second objects in said first axis.

3. The method of claim 2, further comprising:
generating a second capacitive profile associated with said first and second objects, said second capacitive profile comprising capacitance values associated with said first and second objects with respect to a second axis of said sensing region; and
determining locations of said first and second objects in said second axis.

4. The method of claim 3, further comprising:
determining a relationship between said locations in said first axis and said locations in said second axis; and
utilizing said relationship to control a user interface.

5. The method of claim 2 wherein determining locations of said first and second objects comprises:
performing local interpolation on said first capacitive profile.

6. A computer-readable medium have computer-readable code stored thereon for causing a processor to perform a method for determining locations of a plurality of objects contemporaneously interacting with a capacitive touch pad having a sensing region, the method comprising:
generating a first capacitive profile associated with a first object and a second object contemporaneously in said sensing region with respect to a first axis of said sensing region, said first capacitive profile comprising capacitance values associated with said first axis;
determining locations of said first and second objects with respect to said first axis of said sensing region utilizing said first capacitive profile;
generating a second capacitive profile associated with said first object and said second object contemporaneously in said sensing region with respect to a second axis of said sensing region, said second capacitive profile comprising capacitance values associated with said second axis; and
determining locations of said first and second objects with respect to said second axis of said sensing region utilizing said second capacitive profile.

7. The computer readable medium of claim 6 wherein said method further comprises:
determining a relationship between said locations in said first axis and said locations in said second axis; and
utilizing said relationship to control a user interface.

8. The computer readable medium of claim 6 wherein determining locations of said first and second objects with respect to said first axis comprises:
performing local interpolation on said first capacitive profile.

9. The computer readable medium of claim 8 wherein said local interpolation uses a value of a peak electrode and a value of an adjacent electrode.

10. The computer readable medium of claim 6 wherein determining locations of said first and second objects with respect to said second axis comprises:
performing local interpolation on said second capacitive profile.

11. A method for determining locations of a plurality of objects interacting with a capacitive touch pad that generates capacitance profiles comprising:
generating a first capacitance profile associated with a first object proximate said touch pad;
determining a position of said first object with respect to said touch pad based on said first capacitance profile;
generating a second capacitance profile associated with said first object and a second object simultaneously proximate said touch pad;
determining an adjusted capacitance profile based on said first and second capacitance profiles; and
determining a position of said second conductive object with respect to said touch pad based on said adjusted capacitance profile.

12. The method of claim 11 wherein said first and second capacitance profiles are both generated with respect to a first axis of said touch pad.

13. The method of claim 11 further comprising:
using said positions of said first and second objects to emulate a text input device.

14. The method of claim 11 wherein said generating said first capacitance profile occurs prior to said generating said second capacitance profile.

15. The method of claim 11 wherein said determining said adjusted capacitance profile comprises:
scaling one of said first and second capacitance profiles.

16. A capacitance sensing touch pad for determining locations of a plurality of objects comprising:
a capacitance profile generator coupled with said touch pad for generating a first capacitance profile associated with a first object proximate said touch pad;
a position determiner coupled with said profile generator for determining a position of said first object with respect to said touch pad based on said first capacitance profile;
said capacitance profile generator for generating a second capacitance profile associated with said first object and a second object simultaneously proximate said touch pad;
a profile adjuster coupled with said profile generator for determining an adjusted capacitance profile based on said first and second capacitance profiles; and
said position determiner for determining a position of said second conductive object with respect to said touch pad based on said adjusted capacitance profile.

17. The capacitance sensing touch pad of claim 16 wherein said first and second capacitance profiles are both generated with respect to a first axis of said touch pad.

18. The capacitance sensing touch pad of claim 16 further comprising:
a text input emulator for using said positions of said first and second objects to emulate a text input device.

19. The capacitance sensing touch pad of claim 16 wherein said profile generator generates said first capacitance profile prior to generating said second capacitance profile.

20. The capacitance sensing touch pad of claim 16 further comprises:
a profile scaler for scaling one of said first and second capacitance profiles.

21. A module for identifying a plurality of objects interacting with a capacitive touch pad comprising:
a first input for accessing a signal corresponding to a first object proximate said capacitive touch pad;
a profile generator for generating a first capacitive profile associated with said first object;
a second input for accessing a signal indicating a second object proximate said capacitive touch pad, wherein said profile generator is also for generating a second capacitive profile associated with said second object; and
a location determiner for determining locations of said first and second objects with respect to said capacitive touch pad utilizing said first and second capacitive profiles.

22. The module of claim 21 further comprising:
a text input emulator for using said positions of said first and second objects to emulate a text input device.

23. The module of claim 21 further comprising:
a user interface controller for using said locations of said first and second objects to control a user interface.

24. The module of claim 21 wherein said profile generator generates said first capacitance profile prior to generating said second capacitance profile.

25. The module of claim 21 further comprising:
a profile scaler for scaling one of said first and second capacitance profiles.
